(19) United States
(12) Patent Application Publication
(10) Pub. No.: US 2003/0061173 A1
(43) Pub. Date: Mar. 27, 2003

(54) Electronic gathering of product information and purchasing of products

(76) Inventor: Hiroshi Ogino, Palo Alto, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/966,540

(22) Filed: Sep. 27, 2001

(51) Int. Cl. G06F 17/60

(52) U.S. Cl. 705/74; 705/26

(57) ABSTRACT

A transaction device includes a sensor module configured to receive a product identification for a product through a product tag. The transaction device also includes a communication module configured to transmit the product identification and a device identifier associated with the transaction device to a product server through a privacy server to obtain product information from the product server without providing an identification of a user of the transaction device.

### BACKGROUND OF THE INVENTION

1. Field of the Invention

In general the present invention relates to gathering product information and purchasing products electronically, and in particular, relates to user privacy with regard to such gathering and purchasing.

2. Art Background

When a consumer desires to buy products, they visit different stores to obtain product information such as price, vendor, size, specifications, etc. This allows the consumer to perform comparison shopping across a number of different stores that carry the product. At times when visiting the stores, the consumer is not able to speak with a store clerk to obtain this type of product information because the clerk may be busy assisting other customers. If the consumer is fortunate, stores will provide flyers for some of their products describing the product in more detail. However, most stores do not provide individual flyers for each of their products. Accordingly, the consumer will need to have a good memory to remember the product information obtained in the store and/or a pen and paper to write such information down. Even for those consumers that have electronic devices, such as Personal Digital Assistants (PDAs), to maintain this product information within, the consumer will have to manually enter such information into the electronic device.

Additionally, transactions are preformed everyday over different networks, such as the Internet, and through point of sale (POS) or bank systems. Such systems are designed to maintain the integrity of the user's credit card, debit card, and account number. However, no measures are taken to ensure the privacy of the user. As the vendor retains information regarding the identity of the user, the user is open to receipt of marketing materials that may result from the data mining of transactions performed on a particular network.

### SUMMARY OF THE INVENTION

A transaction device includes a sensor module configured to receive a product identification for a product through a product tag. The transaction device also includes a communication module configured to transmit the product identification and a device identifier associated with the transaction device to a product server through a privacy server to obtain product information from the product server without providing an identification of a user of the transaction device.

### BRIEF DESCRIPTION OF THE DRAWINGS

The objects, features and advantages of the present invention will be apparent from the following detailed description in which:

FIG. 1 is a simplified block diagram of one embodiment of a secure transaction system.

FIG. 2 is a simplified block diagram of one embodiment of a privacy card for a personal transaction device.

FIG. 3 is a simplified block diagram of one embodiment of a digital wallet for a personal transaction device.

FIG. 4 illustrates one embodiment of a system configuration for obtaining product information for different products and/or purchasing such products using the transaction device.

FIG. 5 illustrates an embodiment of the transaction device 404.

FIG. 6 illustrates an embodiment of a flow diagram of transactions based on a product tag from a product.

FIG. 7 illustrates one embodiment of a screenshot of the product data retrieved from the product tag and/or from the product servers to allow for purchasing of the product from the product servers.

### DETAILED DESCRIPTION

In the following descriptions for the purposes of explanation, numerous details are set forth in order to provide a thorough understanding of the present invention. However, it will be apparent to one skilled in the art that these specific details are not required in order to practice the present invention. In other instances, well known electrical structures or circuits are shown in block diagram form in order not to obscure the present invention unnecessarily.

In one embodiment, a system and method enable a user to perform transactions, including requesting and gathering product information or conducting purchasing transactions, without compromising the user's personal identification information and identity, while also providing enhanced direct marketing for vendors. The following description discusses embodiments in the context of Internet and point of sale (POS) networks. However, it is readily apparent that the embodiments are not limited to these particular networks, and are applicable to any network that is configured to perform a transaction.

In an embodiment, a personal transaction device can communicate with a product tag associated with a product to provide a product identification. Additionally, the personal transaction device is configured to transmit the product identification and an identifier associated with the personal transaction device to a product server through a privacy server. The privacy server is to communicate the product identification and the identifier to the product server without providing an identification of a user of the personal transaction device. The product server is to communicate product information back to the personal transaction device based on the product identification.

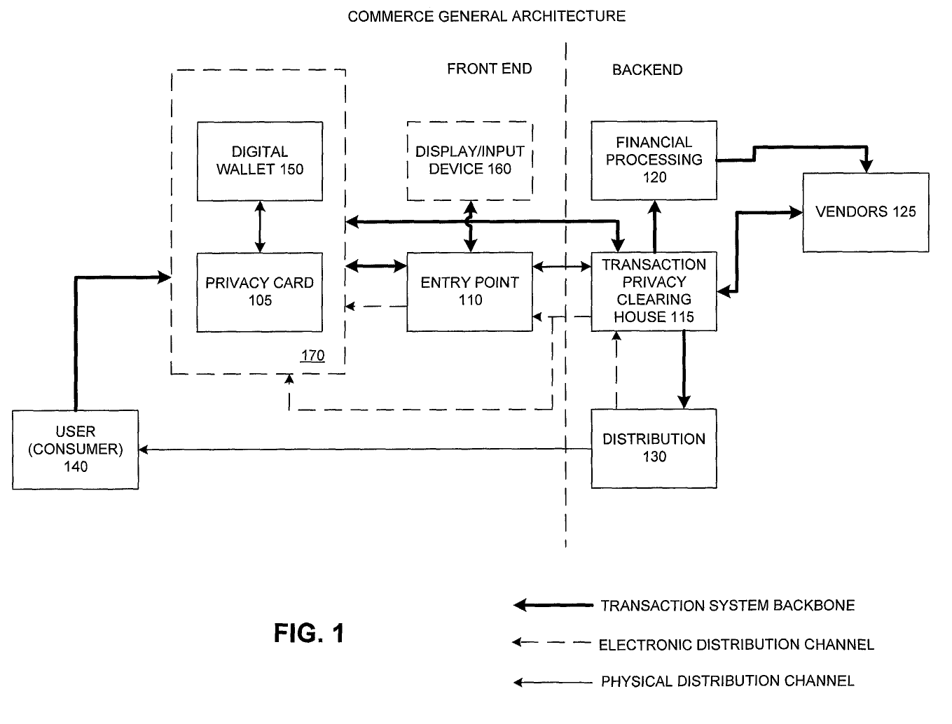

FIG. 1 is a block diagram of one embodiment of a secure transaction system, which may be used in electronic commerce. In this embodiment, a transaction privacy clearing house (TPCH) 115 interfaces a user (consumer) 140 and a vendor 125. In this particular embodiment, a personal transaction device (PTD) 170, e.g., a privacy card 105, or a privacy card 105 coupled to a digital wallet 150, is used to maintain the privacy of the user while enabling the user to perform transactions. In an alternate embodiment, the PTD 170 may be any suitable device that allows unrestricted access to TPCH 130. The personal transaction device information is provided to the TPCH 115 that then indicates to the vendor 125 and the user 140 approval of the transaction to be performed.

In order to maintain confidentiality of the identity of the user 140, the transaction device information does not provide user identification information. Thus, the vendor 125 or other entities do not have user information but rather transaction device information. The TPCH 115 maintains a secure database of transaction device information and user information. In one embodiment, the TPCH 115 interfaces to at least one financial processing system 120 to perform associated financial transactions, such as confirming sufficient funds to perform the transaction, and transfers to the vendor 125 the fees required to complete the transaction. In addition, the TPCH 115 may also provide information through a distribution system 130 that, in one embodiment, can provide a purchased product to the user 140, again without the vendor 125 knowing the identification of the user 140. In an alternate embodiment, the financial processing system 120 need not be a separate entity but may be incorporated with other functionality. For example, in one embodiment, the financial processing system 120 may be combined with the TPCH 115 functionality.

In one embodiment, the financial processing system (FP) 120 performs tasks of transferring funds between the user's account and the vendor's account for each transaction. In one embodiment, the presence of the TPCH 115 means that no details of the transactions, other than the amount of the transactions and other basic information, are known to the FP 120. The TPCH 115 issues transaction authorizations to the FP 120 function on an anonymous basis on behalf of the user over a highly secure channel. The FP 120 does not need to have many electronic channels receiving requests for fund transfer, as in a traditional financial processing system. In one embodiment, a highly secure channel is set up between the TPCH 115 and the FP 120; thus, the FP 120 is less vulnerable to spoofing.

In one embodiment, the FP 120 is contacted by the TPCH 115 requesting a generic credit approval of a particular account. Thus the FP 120 receives a minimal amount of information. In one embodiment, the transaction information, including the identification of goods being purchased with the credit need not be passed to the FP 120. The TPCH 115 can request the credit using a dummy charge ID that can be listed in the monthly credit statement sent to the user, so that the user can reconcile his credit statement. Further, the personal transaction device 105 can include functionality to cause the credit statement to convert the dummy charge ID back to the transactional information so that the credit statement appears to be a conventional statement that lists the goods that were purchased and the associated amount charged.

A display input device 160 (shown in phantom) may be included to enable the user, or in some embodiments the vendor 125, to display status and provide input regarding the PTD 105 and the status of the transaction to be performed.

In yet another embodiment, an entry point 110 interfaces with the personal transaction device 170 and also communicates with the TPCH 115. The entry point 110 may be an existing (referred to herein as a legacy POS terminal) or a newly configured point of sale (POS) terminal located in a retail environment. The user 140 uses the PTD 170 to interface to the POS terminal in a manner similar to how credit cards and debit cards interface with POS terminals. The entry point 110 may also be a public kiosk, a personal computer, or the like.

The system described herein also provides a distribution functionality 130 whereby products purchased via the system are distributed. In one embodiment, the distribution function 130 is integrated with the TPCH 115 functionality. In an alternate embodiment, the distribution function 130 may be handled by a third party. Utilizing either approach, the system ensures user privacy and data security. The distribution function 130 interacts with the user through PTD 130 to ship the product to the appropriate location. A variety of distribution systems are contemplated, for example, electronic distribution through a POS terminal coupled to the network, electronic distribution direct to one or more privacy cards and/or digital wallets, or physical product distribution. In one embodiment for physical product distribution, an “anonymous drop-off point”, such as a convenience store or other ubiquitous location is used. In another embodiment, it involves the use of a “package distribution kiosk” that allows the user to retrieve the package from the kiosk in a secure fashion. However, in one embodiment, the user may use PTD 170 to change the shipping address of the product at any time during the distribution cycle.

A user connects to and performs transactions with a secure transaction system (such as shown in FIG. 1) through a personal transaction device (PTD) that has a unique identifier (ID). In one embodiment, a privacy card is used. In an alternate embodiment a digital wallet is used. In yet another alternate embodiment, a privacy card in conjunction with a digital wallet is used.

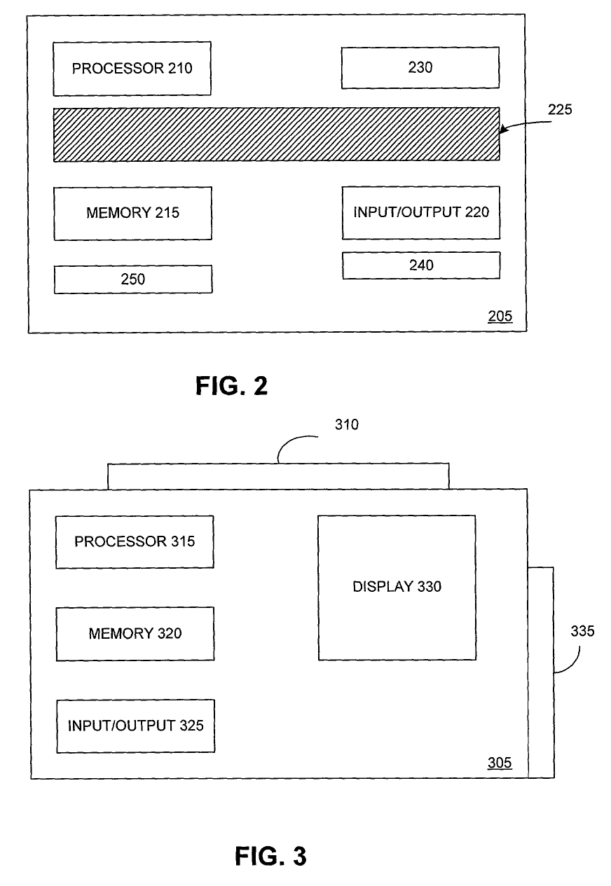

One embodiment of a privacy card 205 is illustrated in FIG. 2. In one embodiment, the card 205 is configured to be the size of a credit card. The privacy card includes a processor 210, memory 215 and input/output logic 220. The processor 210 is configured to execute instructions to perform the functionality herein. The instructions may be stored in the memory 215. The memory is also configured to store data, such as transaction data and the like. In one embodiment, the memory 215 stores the transaction ID used to perform transactions in accordance with the teachings of the present invention. Alternately, the processor may be replaced with specially configured logic to perform the functions described here.

The input/output logic 220 is configured to enable the privacy card 205 to send and receive information. In one embodiment, the input/output logic 220 is configured to communicate through a wired or contact connection. In another embodiment, the logic 220 is configured to communicate through a wireless or contactless connection. A variety of communication technologies may be used.

In one embodiment, a display 225 is used to generate bar codes scanable by coupled devices and used to perform processes as described herein. The privacy card 205 may also include a magnetic stripe generator 240 to simulate a magnetic stripe readable by devices such as legacy POS terminals.

In one embodiment, biometric information, such as fingerprint recognition, is used as a security mechanism that limits access to the card 205 to authorized users. A fingerprint touch pad and associated logic 230 is therefore included in one embodiment to perform these functions. Alternately, security may be achieved using a smart card chip interface 250, which uses known smart card technology to perform the function.

Memory 215 can have transaction history storage area. The transaction history storage area stores transaction records (electronic receipts) that are received from POS terminals. The ways for the data to be input to the card include wireless communications and the smart card chip interface which functions similar to existing smart card interfaces. Both of these approaches presume that the POS terminal is equipped with the corresponding interface and can therefore transmit the data to the card.

Memory 215 can also have user identity/account information block. The user identity/account information block stores data about the user and accounts that are accessed by the card. The type of data stored includes the meta account information used to identify the account to be used.

One embodiment of a digital wallet 305 is illustrated in FIG. 3. The digital wallet 305 includes a coupling input 310 for the privacy card 205, processor 315, memory 320, input/output logic 325, display 330 and peripheral port 335. The processor 315 is configured to execute instructions, such as those stored in memory 320, to perform the functionality described herein. Memory 320 may also store data including financial information, eCoupons, shopping lists and the like. The digital wallet may be configured to have additional storage. In one embodiment, the additional storage is in a form of a card that couples to the device through peripheral port 310.

In one embodiment, the privacy card 205 couples to the digital wallet 305 through port 310; however, the privacy card 205 may also couple to the digital wallet 305 through another form of connection including a wireless connection.

Input/output logic 325 provides the mechanism for the digital wallet 305 to communicate information. In one embodiment, the input/output logic 325 provides data to a point-of-sale terminal or to the privacy card 205 in a pre-specified format. The data may be output through a wired or wireless connection.

The digital wallet 305 may also include a display 330 for display of status information to the user. The display 330 may also provide requests for input and may be a touch sensitive display, enabling the user to provide the input through the display.

The physical manifestation of many of the technologies in the digital wallet 305 will likely be different from those in the privacy card 205, mainly because of the availability of physical real estate in which to package technology. Examples of different physical representations would include the display, fingerprint recognition unit, etc.

Moreover, in one embodiment, external and/or detachable storage in reference to the personal transaction device 170 can be employed for the storage of confidential and non-confidential information or data. In an embodiment, this external and/or detachable storage can be communicatively coupled to the privacy card 205 through a port coupled to input/output logic 220. In one embodiment, this external and/or detachable storage can be communicatively coupled to the digital wallet 305 through coupling port 310 and/or peripheral port 335. In one embodiment, the external and/or detachable storage is a memory stick. However, this is by way of example and not by way of limitation as any other detachable memory storage device can be employed for the storage of confidential and non-confidential information or data.

In one embodiment, the transaction device illustrated in FIGS. 1-3 above can be employed by the user to obtain product information and consummate purchasing transactions related to different products using a product tag, such as a bar code, that is associated with a given product. In an embodiment, a user of the transaction device can consummate the purchasing transactions at a POS terminal, as described above in conjunction with FIG. 1. In one embodiment, the user of the transaction device can consummate the purchasing transactions by transmitting requests to the associated product servers using the transaction device.

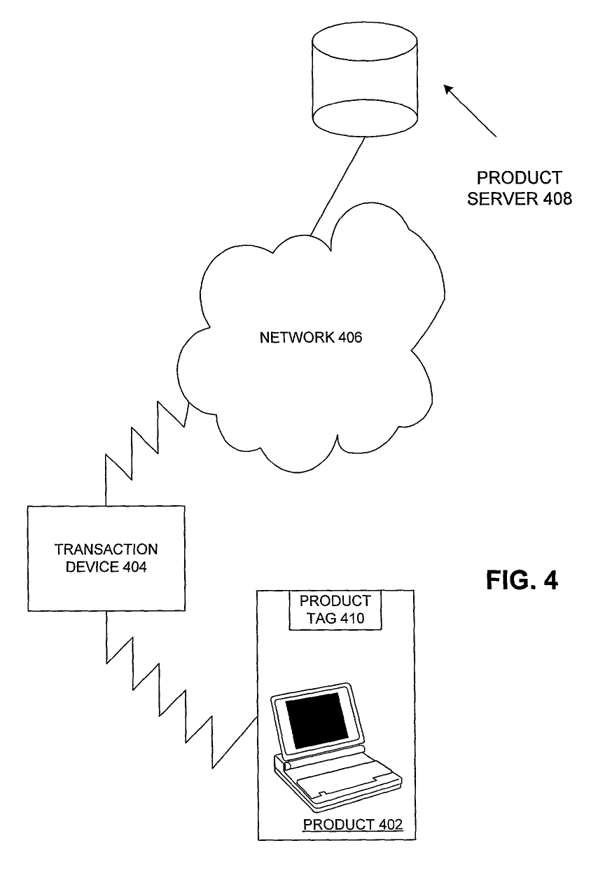

FIG. 4 illustrates one embodiment of a system configuration for obtaining product information for different products and/or purchasing such products using the transaction device. As shown, FIG. 4 includes a transaction device 404, which can include the different embodiments described herein. As shown, the transaction device 404 is communicatively coupled to a product tag 410 that is associated with a product 402, which is illustrated as a notebook computer. Examples of the product tag can include a bar code on the box of the product or a bar code located on the shelf where the product is placed in a store. Moreover, the transaction device is communicatively coupled to a network 406. The network 406 is also communicatively coupled to a product server 408.

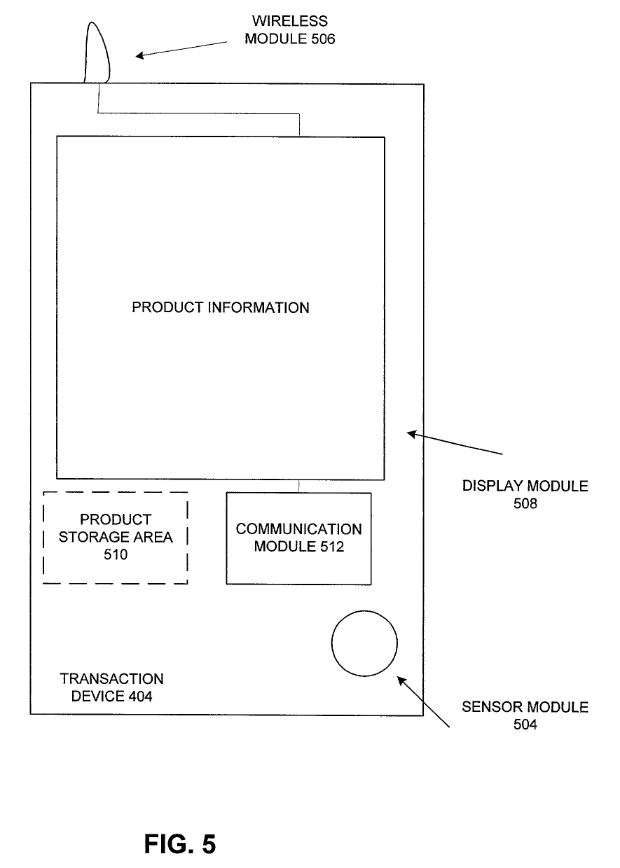

In one embodiment, the network 406 is a local area network (LAN). In another embodiment, the network 406 is a wide area network (WAN). In an embodiment, the network 406 is the Internet. Further, the network 406 can be a combination of different networks that provide communication between the transaction device 404 and the server 408. While different embodiments could have different types of communication between the network 406 and the transaction device 404, in one embodiment, the transaction device 404 is communicatively coupled to the network 406 through wireless communication, while a server 408 is coupled to the network 406 through wired communication. Moreover, to allow for increased security regarding the communications among the transaction device 404, the network 406 and the server 408, virtual private networks (VPNs) can be established among such devices and networks. Additionally (not shown), the network 406 can include servers associated with a privacy server (such as the TPCH 115) the financial processing 120 and the distribution 130 of FIG. 1. The operation of the system configuration of FIG. 4 will be described in more detail below in conjunction with FIGS. 5-8.

FIG. 5 illustrates an embodiment of the transaction device 404. The embodiment of the transaction device 404 illustrated in FIG. 5 include those units or components illustrating the obtaining of product information and the consummating of purchasing transactions related to different products using the product tag that is associated with a given product. However, the number of components illustrated within the transaction device 404 is for the sake of simplicity and not by way of limitation as other components included in other embodiments of a transaction device can be included within the transaction device 404. The transaction device 404 includes a sensor module 504 that can communicate with the product tag for an associated product. In an embodiment, this communication can be wireless. In another embodiment, this communication is through a scanning by the sensor module 504 of the product tag.

Additionally, the transaction device 404 includes a communication module 512 that can communicate with the product tag for an associated product through sensor module or different servers/websites, such as product server 408, through a wireless module 506 or other module for network communication. As described, the transaction device 404 includes a wireless module 506. In an embodiment, the wireless module 506 includes an antenna to allow the transaction device 404 to perform wireless communication with the product server 408 through the network 406. This form of communication between the transaction device 404 and the product server 408 is by way of example and not by way of limitation, as there can be other forms of communication between the transaction device 404 and the product server 408. For example, in one embodiment, the transaction device 404 could be coupled to another computing device that is wired to the product server 408 through the network 406.

Additionally, the transaction device 404 includes a product storage area 510 that allows the consumer to store product information about different products within the transaction device 404. Although the product storage area 510 can be included in different types of memory, in an embodiment, the product storage area 510 is stored in random access memory. In one embodiment, this product information is received from the product tag 410 and/or the product server 408. Moreover, the transaction device 404 can include a display module 508 for the display of product information.

A user could be supplied this transaction device through various means including shipment based on an Internet order, purchase at various stores and/or banks, etc. In one such embodiment, the identification of the transaction device is associated with the user and such association is stored within transaction privacy clearinghouse 115 (illustrated in FIG. 1).

Additionally, TPCH 115 maintains the association between the user of the personal transaction device and the personal transaction device. In one such embodiment, this association is based on a transaction device identifier that is associated with the user. As previously described in conjunction with FIG. 1, the TPCH 115 maintains a secure database of transaction device information and user information. Accordingly, the TPCH 115 provides the identification of the personal transaction device without the identity of the user to different entities that the user interfaces with using the personal transaction device, such as the vendors 125.

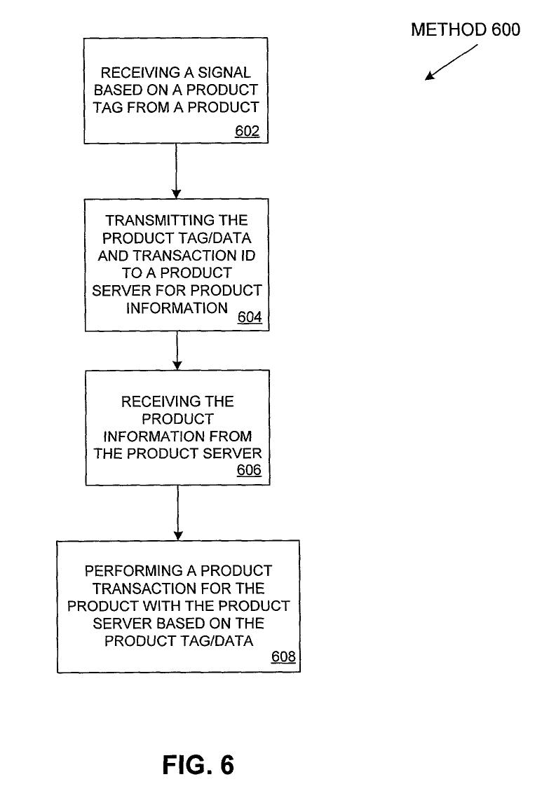

Moreover, the obtaining of product information and/or consummating a purchasing transaction is conducted through a privacy server, such as TPCH 115, with an entity, such as the vendors 125 that include product servers, based on a request and/or data from the transaction device as described above in conjunction with FIG. 1. To help illustrate such a purchasing transaction, FIG. 6 illustrates an embodiment of a flow diagram of transactions based on a product tag from a product. Method 600 of FIG. 6 commences with the receiving of a signal based a product tag from a product, at process block 602. As described above in conjunction with FIG. 4, examples of the product tag can include a bar code on the box of the product or a bar code located on the shelf where the product is placed in a store.

The receiving of the signal based on the product tag could originate based on when a user of the transaction device scans the product tag of a given product in a store and/or receives a wireless communication through sensor module 504. For example, the user could be a consumer in a store wherein the user uses the sensor module 504 to scan the product tag 410 which can be located on the product 402 or in close proximity thereto, such as on the shelf. Accordingly, the product tag 410 communicates product data to the transaction device 404. In an embodiment, the product data includes a product identification. In one embodiment, the product data includes product information. Examples of types of product information can include a price, vendor, size, specifications, etc. for a given product.

Upon receipt of the product data, the transaction device can store such data into the product storage area 510. In one embodiment, the transaction device can display the product data on the display module 508. Additionally, in an embodiment, the user can cause the transaction device 404 to transmit a request, using the wireless module 506, for product information to the product servers or websites, such as vendors 125, through TPCH 115, (such that the user's identity is not revealed to the vendors), at process block 604. For example, the transaction device could multicast the request based on the product tag to a number of different vendor's websites to obtain different information about the product and different versions thereof.

In one embodiment, the product data received based on the product tag can include the addresses (e.g., the Uniform Resource Language (URL) address) of the product server(s) from which the product information can be retrieved. In an embodiment, the addresses of the product server(s) can be stored in the privacy server. The locations of the addresses of the product server(s) are by way of example and not by way of limitation, as other locations can store these addresses for retrieval. For example, these addresses could be stored in a server within the network that the transaction device can query for such addresses.

The transaction device then receives the requested product information back from these different product servers or websites, at process block 606. In one embodiment, this received product information could be stored in product storage area 510. The transaction device can also perform a purchasing transaction based on the product tag and/or product data, at process block 608. In one embodiment, the user uses the personal transaction device as a credit card to purchase a product at one of the number of different POS terminals, as previously described in conjunction with FIG. 1. In an alternative embodiment, the user uses the personal transaction device to purchase the product from a product server through a privacy server in a network.

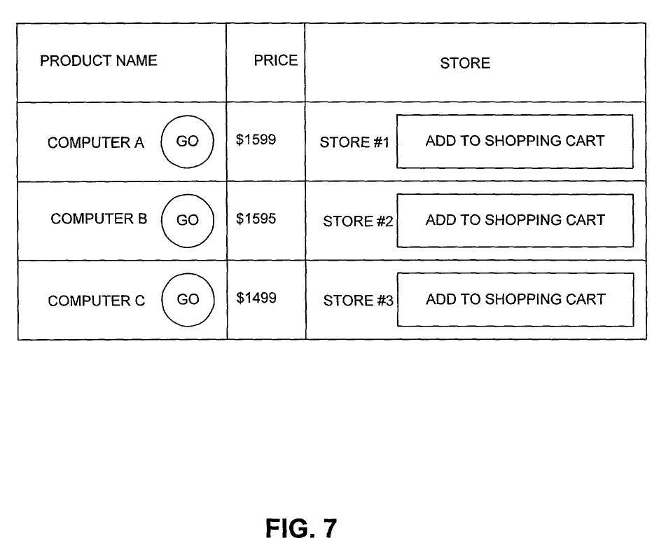

FIG. 7 illustrates one embodiment of a screenshot of the product data retrieved from the product tag and/or from the product servers to allow for purchasing of the product from the product servers. As shown, different products can be displayed on display module 508 that include the price, the store location and buttons (“add to shopping cart”) to allow for the purchase of the different products from the transaction device. Additionally, the “go” buttons illustrated in FIG. 8 allow the user to receive additional product information about the listed product in another screenshot by pressing the associated “go” buttons.

For example, the user of the transaction device could press the “add to shopping cart” button for the associated product, which could cause transaction device to transmit a request to the related product server for the purchase of the product. In one embodiment, this purchasing transaction is performed through TPCH 115 and is conducted with the servers and websites of the different vendors of the product, such as vendors 125. Accordingly, the transaction is based on the identity of the transaction device and not that of the user, thereby precluding the vendors from knowing the identity of the user that is performing the purchasing transaction.

In one embodiment, the user can cause the transaction device to issue a request through TPCH 115 to a financial processing institution (such as financial processing 120 of FIG. 1). Such a request could include instructions to transfer finds to vendors 125 in an amount associated with the purchasing transaction for the product. In an embodiment, data mining operations and/or direct marketing could be performed based on this purchasing transaction, based on the identification of the transaction device without identification of the user of the device. In one embodiment, the vendor or product server transmits coupons to the TPCH 115 for distribution to the user based on the transaction identifier that was received by for product information.

Transaction device 404 and the different servers described herein can include memory and processors. The memory can include a machine-readable medium on which is stored a set of instructions (i.e., software) embodying any one, or all, of the methodologies described above. Software can reside, completely or at least partially, within the memory and/or within the processors. For the purposes of this specification, the term “machine-readable medium” shall be taken to include any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

Embodiments have described protection of an identity of a user of a personal transaction device with regard to the obtaining of product information and the purchasing of the product. In one embodiment, the identity of the user can be protected while obtaining the product information and while purchasing the product (either through a POS terminal or from a product server). In an alternative embodiment, the identity of the user can be protected while obtaining the product information, but not while purchasing the product. In another embodiment, the identity of the user could be unprotected while obtaining product information, but protecting the identity of the user while purchasing the product.

Embodiments have been described in conjunction with the preferred embodiment. It is evident that numerous alternatives, modifications, variations and uses will be apparent to those skilled in the art in light of the foregoing description.

What is claimed is:

1. A transaction device comprising:
a sensor module configured to receive a product identification for a product through a product tag; and
a communication module configured to transmit the product identification and a device identifier associated with the transaction device to a product server through a privacy server to obtain product information from the product server without providing an identification of a user of the transaction device.

2. The transaction device of claim 1, wherein the product server is to communicate product information back to the transaction device based on the product identification

3. The transaction device of claim 1, wherein the communication module is to transmit a request to purchase the product to the product server through the privacy server without providing the identification of the user of the transaction device.

4. The transaction device of claim 1, wherein the product tag includes product information for the product.

5. The transaction device of claim 1, wherein the transaction device is selected from the group consisting of a privacy card, digital wallet, and a privacy card configured to be coupled to a digital wallet.

6. The transaction device of claim 1, further comprising a product storage area configured to store the product information for a number of products.

7. An electronic transaction device comprising:
a sensor module configured to receive a product identification for a product through a product tag associated with the product;
a wireless module configured to communicate with a privacy system, the privacy system comprising a secure mechanism for correlating an identifier of the electronic transaction device with a user authorized to use the electronic transaction device; and
a communication module configured to communicate the transaction device identifier and the product identification through the wireless module to the privacy system to perform a transaction for the product.

8. The electronic transaction device of claim 7, further comprising:
a display module configured to display the product information for the product received from the privacy system.

9. The electronic transaction device of claim 7, wherein the product tag for the product includes product information.

10. The electronic transaction device of claim 7, wherein the user of the electronic transaction device can purchase the product from a vendor through the secure mechanism using the wireless module based on the product identification and the transaction device identifier.

11. The electronic transaction device of claim 7, wherein the communication module is to transmit a request to purchase the product to the privacy system without providing the identification of the user of the transaction device.

12. The electronic transaction device of claim 7, wherein the electronic transaction device is selected from the group consisting of a privacy card, digital wallet, and a privacy card configured to be coupled to a digital wallet.

13. The electronic transaction device of claim 7, further comprising a product storage area configured to store product information for a number of products.

14. A method comprising:
receiving, at a transaction device, a signal based on a product tag associated with a product;
transmitting the product tag to a product server through a privacy server indicating a request of product information based on the product tag without providing an identity of a user of the transaction device; and
receiving the product information from the product server.

15. The method of claim 14, further comprising performing a product transaction for the product with the product server through the transaction privacy clearinghouse using a device identifier for the transaction device, wherein the identity of the user is not known to the product server.

16. The method as set forth in claim 15, wherein performing the electronic commerce transaction for the product includes receiving eCoupons related to the product from the vendor through the transaction privacy clearinghouse.

17. The method as set forth in claim 15, wherein performing the electronic commerce transaction for the product includes purchasing the product from the vendor through the transaction privacy clearinghouse.

18. An electronic system comprising:
a personal transaction device configured to communicate with a product tag associated with a product to receive a product identification for the product, the personal transaction device having an identifier;
a privacy server coupled selectively to the personal transaction device when a transaction related to the product is to be performed based on the product identification, said privacy server authorizing the transaction based upon the identifier and account information of a user that is authorized to use the transaction device, wherein the transaction is with a vendor of the product and wherein an identity of the user is not provided to the vendor.

19. The electronic system as set forth in claim 18, wherein the transaction includes transmitting eCoupons from the vendor to the transaction device through the privacy server without providing the identity of the user to the vendor.

20. The electronic system as set forth in claim 18, wherein the transaction includes purchasing the product from the vendor through the privacy server without providing the identity of the user to the vendor.

21. The electronic system as set forth in claim 18, wherein the personal transaction device is selected from the group consisting of a privacy card, digital wallet, and a privacy card configured to be coupled to a digital wallet.

22. The electronic system as set forth in claim 18, wherein the privacy server is further configured to selectively couple to a financial institution.

23. The electronic system as set forth in claim 18, wherein the privacy server further comprises a financial institution.

24. The electronic system as set forth in claim 18, wherein the privacy server comprises a secure database of transaction device information and user information, said database accessed for authorizing the transaction.

25. The electronic system as set forth in claim 18, wherein the privacy server is configured to interface to a financial processing system configured to perform financial transactions associated with the transaction.

26. A machine-readable medium that provides instructions, which when executed by a machine, cause said machine to perform operations comprising:
receiving, at a transaction device, a signal based on a product tag associated with a product;
transmitting the product tag to a product server through a transaction privacy clearinghouse indicating a request of product information based on the product tag; and
receiving the product information from the product server without providing an identity of a user of the transaction device.

27. The machine-readable medium of claim 26, further comprising performing an electronic commerce transaction for the product with the product server through the transaction privacy clearinghouse using a device identifier for the transaction device, wherein the identity of the user is not known to the product server.

28. The machine-readable medium of claim 27, wherein performing the electronic commerce transaction for the product includes receiving eCoupons related to the product from the vendor through the transaction privacy clearinghouse.

29. The machine-readable medium of claim 27, wherein performing the electronic commerce transaction for the product includes purchasing the product from the vendor through the transaction privacy clearinghouse.
